(19) United States
(12) Patent Application Publication
(10) Pub. No.: US 2025/0156149 A1
(43) Pub. Date: May 15, 2025

(54) COMPACT AND PVT-ROBUST PROCESSING-IN-MEMORY MACRO WITH ACCURATE ANALOG SHIFT-AND-ADD

(71) Applicant: William Marsh Rice University, Houston, TX (US)

(72) Inventors: Kaiyuan Yang, Houston, TX (US); Zhiyu Chen, Houston, TX (US)

(73) Assignee: William Marsh Rice University, Houston, TX (US)

(21) Appl. No.: 18/941,878

(22) Filed: Nov. 8, 2024

Related U.S. Application Data
(60) Provisional application No. 63/597,606, filed on Nov. 9, 2023.

(51) Int. Cl. G06F 7/544; G06F 7/527; G06F 17/16

(52) U.S. Cl. CPC G06F 7/5443; G06F 7/5272; G06F 17/16

(57) ABSTRACT

A processing-in-memory (PIM) macro device and a method are disclosed. The PIM macro device includes a plurality of capacitor-based digital-to-analog converters (C-DACs) and a plurality of multiply-and-add (MAC) units. Each MAC unit includes a plurality of slices, where each slice comprises a plurality of clusters, and where each cluster includes a 6-transitor (6T) static random-access memory (SRAM) cell and a MAC module. Each MAC unit further includes a partial-sum combiner (P-Sum Combiner), an analog-to-digital converter (ADC), and a Share Line, a MAC Line, a plurality of wordlines (WLs), and a local bitline (LBL). The PIM macro device further includes an array of metal-oxide-metal (MOM) capacitors, where the MOM capacitors are shared between the C-DACs and the MAC units, an array of switches configured to be controlled to configure the MOM capacitors to perform a first operation and to reconfigure the MOM capacitors to perform a second operation.

### CROSS-REFERENCE TO RELATED APPLICATION

This International Patent Application claims priority from U.S. Provisional Application No. 63/597,606, filed on Nov. 9, 2023. The content of this application is hereby incorporated by reference herein in its entirety.

### BACKGROUND

The development of a macro capable of performing accurate analog shift-and-add operations is significant in the context of processing-in-memory (PIM) technology. PIM is an emerging computer architecture paradigm that seeks to integrate processing and memory functions to enhance the efficiency of data processing, particularly for data-intensive tasks such as machine learning and signal processing. One of the challenges in PIM is the need to perform analog operations accurately and efficiently within memory modules.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a processing-in-memory (PIM) macro device comprising a plurality of capacitor-based digital-to-analog converters (C-DACs), wherein the C-DACs transform a digital input into an analog voltage, a plurality of multiply-and-add (MAC) units, each MAC unit comprising a plurality of slices, wherein each slice comprises a plurality of clusters, wherein each cluster in the plurality of clusters comprises a 6-transitor (6T) static random-access memory (SRAM) cell and a MAC module, a partial-sum combiner (P-Sum Combiner) that performs a shift-and-add operation across multiple slices within the MAC unit, an analog-to-digital converter (ADC) configured to convert a final output voltage from the P-Sum Combiner into a digital output, and a Share Line, a MAC Line, a plurality of wordlines (WLs), and a local bitline (LBL), an array of metal-oxide-metal (MOM) capacitors configured to store a charge, each capacitor comprising a top plate and a bottom plate, wherein the MOM capacitors are shared between the C-DACs and the MAC units, and an array of switches configured to be controlled to configure the MOM capacitors to perform a first operation and to reconfigure the MOM capacitors to perform a second operation.

Embodiments disclosed herein generally relate to a method for operating a processing-in-memory (PIM) macro device, comprising transforming a digital input into an analog voltage using a plurality of capacitor-based digital-to-analog converters (C-DACs), wherein the C-DACs comprise an array of metal-oxide-metal (MOM) capacitors configured to store a charge, each capacitor comprising a top plate and a bottom plate, wherein the MOM capacitors and are shared between the C-DACs and a plurality of PIM multiply-and-add (MAC) units, controlling an array of switches to configure the MOM capacitors to perform a pre-charging operation comprising setting the top plate of the MOM capacitors to a ground voltage, setting a MAC Line to a VDD voltage, and setting a Share Line to a ground voltage, and controlling the array of switches to reconfigure the MOM capacitors to perform a digital-to-analog operation comprising setting the top plate of the MOM capacitors to a voltage determined based on a bit value of the digital input, sharing a charge stored in the top plate of the MOM capacitors between one or more MAC modules using the Share Line, and setting the bottom plate of the MOM capacitors to a ground voltage using the MAC Line.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts the architecture of a processing-in-memory (PIM) macro device in accordance with one or more embodiments.

FIGS. 2A and 2B depict a cluster and an implementation of the cluster, respectively, in accordance with one or more embodiments.

FIGS. 3A and 3B depict a layout of a MAC module and integration of the MAC module with 6T SRAM cells, respectively, in accordance with one or more embodiments.

FIGS. 4A and 4B depict a diagram of an embedded capacitor-based digital-to-analog converter (C-DAC) and an implementation of the C-DAC, respectively, in accordance with one or more embodiments.

FIG. 5A and 5B depict a diagram of shift-and-add circuits and an implementation of the shift-and-add circuits, respectively, in accordance with one or more embodiments.

FIG. 6 depicts a diagram of an analog-to-digital converter (ADC) in accordance with one or more embodiments.

FIG. 7 depicts operational waveforms of the ADC in accordance with one or more embodiments.

FIG. 8A depicts operational waveforms of the PIM macro operation in accordance with one or more embodiments.

FIG. 8B-8C depict configurations of the MOM capacitors during the multiplication and accumulation phases in accordance with one or more embodiments.

FIGS. 8D-8F depict configurations of metal-oxide-metal (MOM) capacitors during a first phase of digital-to-analog operation (DAC-P1), during a second phase of digital-to-analog operation (DAC-P1), and during a shift-and-add (S.A.) operation, respectively, in accordance with one or more embodiments.

FIGS. 9A and 9B depict a die micrograph and a layout of a fabricated PIM macro, respectively, in accordance with one or more embodiments.

FIGS. 10A-10C depict linearity measurements of MAC units in accordance with one or more embodiments.

FIGS. 10D and 10E depict Differential Non-Linearity (DNL) and Integral Non-Linearity (INL) performance, respectively, in accordance with one or more embodiments.

FIGS. 11A and 11B depict the influence of thermal noise on a PIM macro in accordance with one or more embodiments.

FIG. 12 depicts the linearity of shift-and-add circuits in accordance with one or more embodiments.

FIGS. 13A-13E depict Process, Voltage, Temperature (PVT) and gain variations of MAC units in accordance with one or more embodiments.

FIG. 14 depicts a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “capacitor” may include any number of “capacitors” without limitation. Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

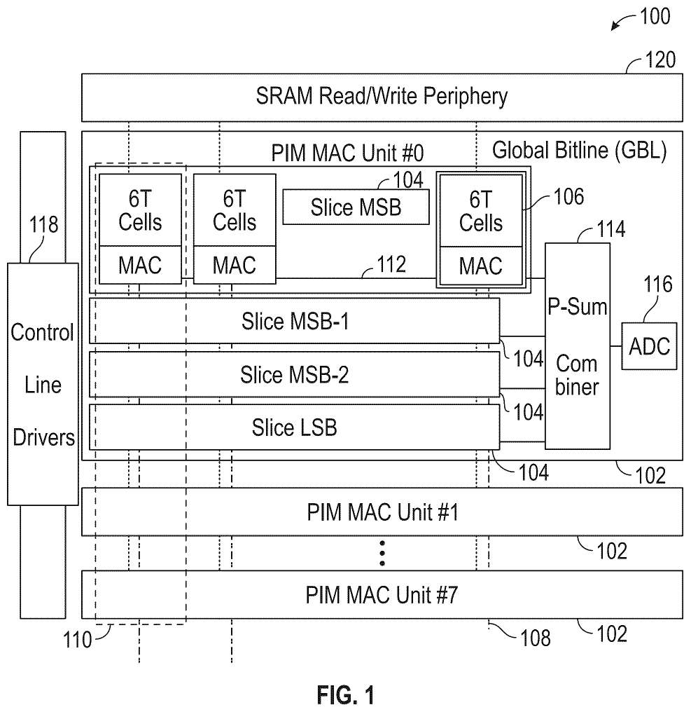

In the following description of FIGS. 1-14, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Analog processing-in-memory (PIM) in static random-access memory (SRAM) is promising for accelerating deep learning inference by circumventing the memory wall and exploiting ultra-efficient analog low-precision arithmetic. Latest analog PIM designs attempt bit-parallel schemes for multi-bit analog matrix-vector multiplication (MVM), aiming at higher energy efficiency, throughput, and training simplicity and robustness over conventional bit-serial methods that digitally shift-and-add multiple partial analog computing results. However, bit-parallel operations require more complex analog computations and become more sensitive to well-known analog PIM challenges, including large cell areas, inefficient and inaccurate multi-bit analog operations, and vulnerability to Process, Voltage, and Temperature (PVT) variations. Overall, an ideal PIM macro design should encompass a compact cell array and periphery, achieving multi-bit MVM with high accuracy and PVT robustness, and eliminating power-consuming analog buffers.

Embodiments disclosed herein generally relate to a PVT-robust and compact PIM SRAM macro with charge-domain bit-parallel computation. Specifically, the PIM macro device adopts (1) a charge-domain 4-bit multiply-and-add (MAC) module with a 6T-thin-cell-compatible layout, (2) an accurate in-situ charge-domain shift-and-add circuit, (3) a PVT-robust in-situ capacitive DAC (C-DAC) without power-consuming analog buffers, and (4) a compact and low-power dual-threshold time-domain ADC with power gating of the continuous comparator and D-flip-flops (DFFs). The terms “PVT-robust” and “PVT-insensitive” as used herein mean the same and may be used interchangeably to refer to reusing the same set of capacitors embedded in the PIM macro. Further, the term “in-situ” as used herein may be interpreted to mean “embedded and charge-sharing.” All analog computing modules, including capacitor-based digital-to-analog converters (DACs), MAC units, analog shift-and-add circuits, and analog-to-digital converters (ADCs) disclosed herein reuse one set of local metal-oxide-metal (MOM) capacitors inside the array, performing in-situ computation to save area and enhance accuracy. A compact 8.5-bit dual-threshold time-domain ADC power gates the main path most of the time, leading to a significant energy reduction. Depictions of various configurations of the PIM macro and methods of its use are provided in FIGS. 1-14, along with accompanying descriptions.

FIG. 1 shows the architecture of a processing-in-memory (PIM) macro device (100) in accordance with one or more embodiments. As shown in FIG. 1, the PIM macro (100) contains eight MAC units (102) (i.e., MAC Unit #0, MAC Unit #1, . . . , MAC Unit #7.). Four slices (104) are present within each MAC unit (102): slice MSB, slice MSB-1, slice MSB-2, and slice LSB. Each slice performs charge-domain vector-vector multiplication with 4-bit activations (Xᵢ) and 4-bit weights (Wᵢ), where each bit of the weights is stored in a corresponding slice. Each slice includes 144 clusters (106). Each cluster (106) consists of nine 6-transitor (6T) static random-access memory (SRAM) cells used to store weights (Wᵢ) and a thin-cell MAC module. The MAC module performs multi-bit charge-domain multiply-and-add. During operation of the PIM macro (100), the 4-bit digital inputs (108) (i.e., activations Xᵢ) are first transformed into analog voltage with an embedded capacitor-based digital-to-analog converters (C-DACs) (110) and multiply the weights (Wᵢ) stored in the 6T SRAM cells in the charge-domain. Results from different clusters (106) in a row then accumulate on a MAC Line (112) using charge-sharing. A partial-sum combiner (P-Sum Combiner) (114) shift-and-adds the charge-sharing results of the four adjacent slices (104) in the charge-domain and transmits the final output voltage to an analog-to-digital converter (ADC) (116) for digitalization. In some embodiments, the ADC is a dual-threshold time-domain (TD) ADC. For the periphery, the control line drivers (118) on the left side drive the control signals, while the SRAM read/write periphery circuits (120) on the top complete the normal SRAM read and write operation.

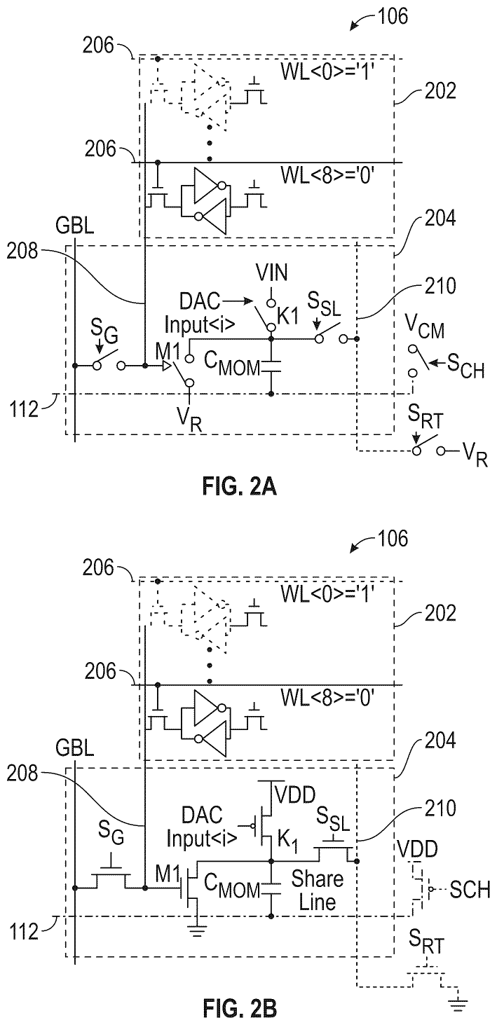

As previously stated, the building block of the PIM macro (100) is the cluster (106). FIG. 2A shows a diagram of the cluster (106). Each cluster (106) consists of a 6T SRAM cell (202) that store weights (Wᵢ) and a MAC module (204). The cluster (106) activates only one of the wordlines (WLs) (206) during each MAC operation. Further, only one of the nine 6T SRAM cells (202) are accessed in each operation, while the rest of the inactive 6T SRAM cells (202) store weights from other layers or channels to improve storage density.

The MAC module (204) performs charge-domain MAC of a 4-bit digital input (108) and a 4-bit weight (Wᵢ) and include an array of switches: K₁, M₁, S_{G}, S_{SL}, S_{CH} and S_{RT}. The K₁ switch is controlled by a bit from the 4-bit digital input (108). The multiplier switch M₁ is controlled by a local bitline (LBL) (208). S_{CH} and S_{RT} are shared horizontally (i.e., row-wise) via a MAC Line (112) and vertically (i.e., column-wise) via a Share Line (210), respectively. In accordance with one or more embodiments, the array of switches may be implemented using an N-channel metal-oxide semiconductor (NMOS) transistor, a p-channel metal-oxide semiconductor (PMOS) transistor, or a transmission gate. For simplicity, the wordline and bitline for the access transistors on the right side of the 6T SRAM cells (202), which are only used for normal read/write, are omitted in FIG. 2A.

Continuing with FIG. 2A, the MAC module (204) includes a metal-oxide-metal (MOM) capacitor (C_{MOM}) used for the charge-domain MAC. The MOM capacitor is fabricated above the 6T SRAM cells (202) to save area. The logic high voltage V_{IN} may be either VDD or ground, while the reset voltage V_{R} may be ground or VDD, respectively. V_{CM} sets the zero point of the charge-domain MAC to match the input range of the ADC (116). FIG. 2B shows a specific implementation of the cluster (106) in accordance with one or more embodiments. As shown, in such an embodiment the switches K₁, S_{G}, S_{SL}, S_{CH}, and S_{RT} are transistors and the multiplier switch M₁ is an NMOS transistor. Further, the logic high voltage V_{IN} is equal to VDD, V_{R} is ground, and V_{CM} is equal to VDD.

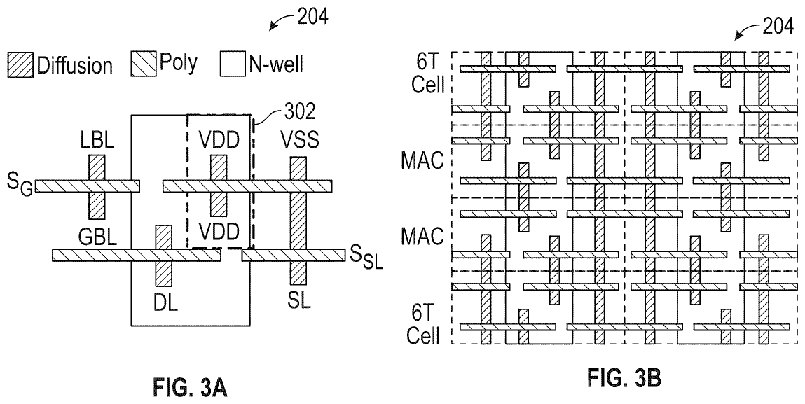

As previously stated, the PIM macro (100) adopts a multi-bit thin-cell MAC module (204) that shares the same transistor layout as the most compact 6T SRAM cell (202), differing only in metal connections. FIG. 3A illustrates the layout of the MAC module (204). With such a thin-cell cluster, the weight storage density may approach that of a commercial SRAM if the same push-rule layout is adopted, and the matching between transistors is also improved due to the regular layout. As shown in FIG. 3A, a dummy PMOS slice (302) with drain and source connected to VDD is added to achieve better uniformity of the layout. Further, as noted, the MOM capacitor (˜4 fF) within the MAC module (204) is fabricated above the cluster to save area. FIG. 3B shows the integration of the MAC module (204) with 6T SRAM cells (202). The MAC module (204) has the same area as a standard 6T SRAM cell (202) and can be seamlessly merged into the memory array. In one or more embodiments, the layout is verified using 28 nm Complementary Metal-Oxide-Semiconductor (CMOS) technology, achieving the same arca as a 6T SRAM cell (202) with an area of 0.27 square micrometer (μm²).

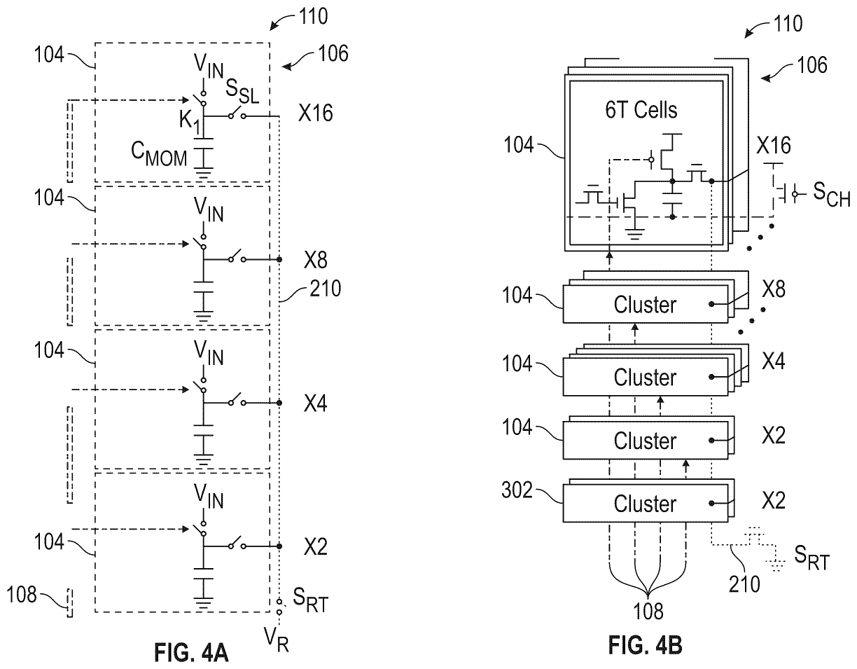

FIG. 4A shows a diagram of the embedded C-DAC (110) in accordance with one or more embodiments. The C-DAC (110) achieves a smaller area overhead by reusing the MOM capacitors in the memory array as a capacitive voltage divider. Further, the MOM capacitors also sample the output voltage of the C-DAC (110) so that no extra analog output buffers are required. Inside the C-DAC (110), 32 clusters (106) combine into a column with a Share Line (210) connected together. To realize the embedded C-DAC (110), one memory column is divided into 4 slices (104). As previously stated, the switches K₁ in each slice (104) are controlled by a different bit from the 4-bit digital input (108). The number of clusters in a slice (104) (i.e., 16, 8, 4, and 2) represents the weight of the corresponding digital input (108) bit. FIG. 4B illustrates an implementation of the C-DAC (110) using the MAC module (204) of FIG. 2B in each cluster (106) in accordance with one or more embodiments. Embodiments disclosed herein operate in the charge-domain and are therefore robust to PVT variations compared to conventional current-steering C-DACs. Further, the C-DAC (110) disclosed herein has a much smaller area overhead than designs with explicit voltage dividers and power-consuming analog buffers.

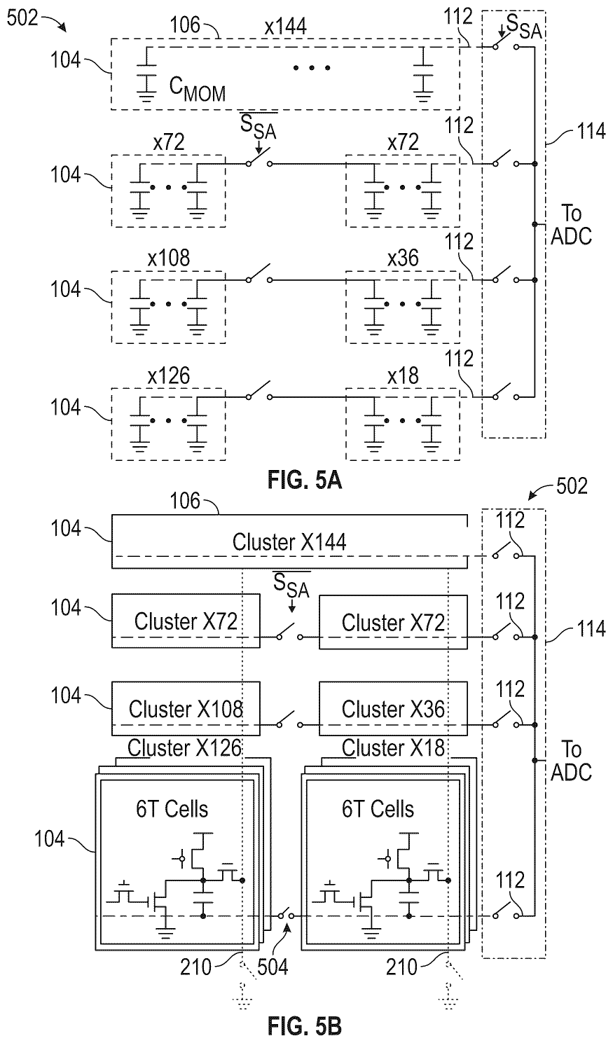

FIG. 5A shows a diagram of the shift-and-add circuits (502) in accordance with one or more embodiments. Similar to the C-DAC (110), the shift-and-add circuits (502) achieve a smaller area overhead by reusing the MOM capacitors in the memory array for weighted charge-sharing. As shown in FIG. 5A, the 144 clusters (106) integrate into a slice (104) where their MAC Line (112) is connected together. Inside the slices (104) MSB-1, MSB-2, and LSB, separation switches (504) (S̅_̅{̅S̅A̅}̅) are inserted to disconnect the MAC Lines (112). The number of clusters (e.g., 72, 36, and 18) on the right side of the separation switch (504) represents the bit's weight. All clusters (144 in total) in the MSB slice (104) participate in the weighted summation. As such, for slice MSB (104), no separation switch (504) is inserted because all 144 clusters (106) are involved in the weighted summation. The shift-and-add happens right after the conventional charge-domain computation on the MAC Line (112), when the accumulation results are ready on the MOM capacitors, as explained in greater detail below. The P-Sum Combiner (114) shift-and-adds the charge-sharing results of the four adjacent slices (104) in the charge-domain and transmits the final output voltage to the ADC (116) for digitalization. FIG. 5B illustrates an implementation of the shift-and-add circuits (502) using the MAC module (204) of FIG. 2B in each cluster (106) in accordance with one or more embodiments. Embodiments disclosed herein achieve superior capacitive matching, compactness, and computing accuracy due to the uniform placement of the MOM capacitors, which combine into a large total capacitance value and greatly alleviate any parasitic effects.

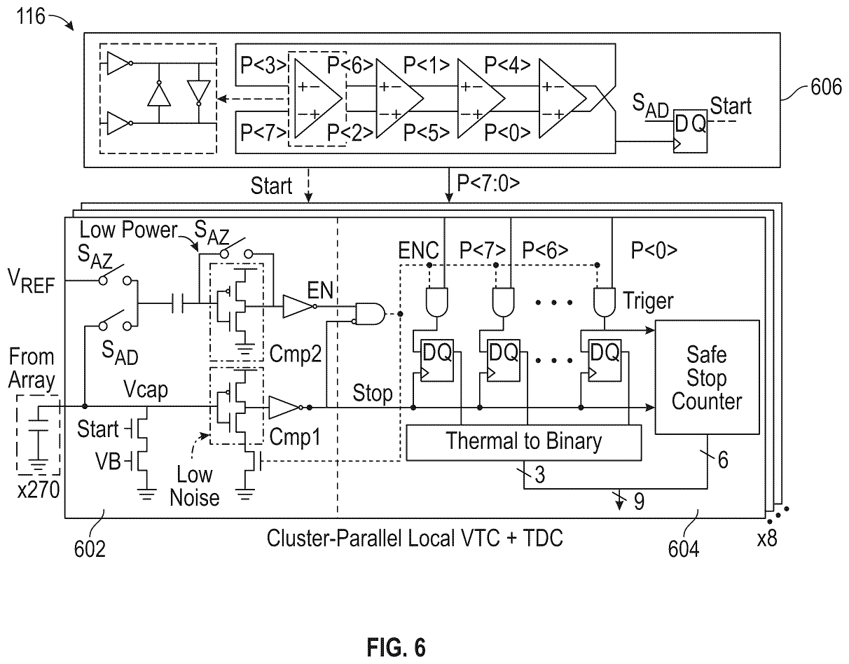

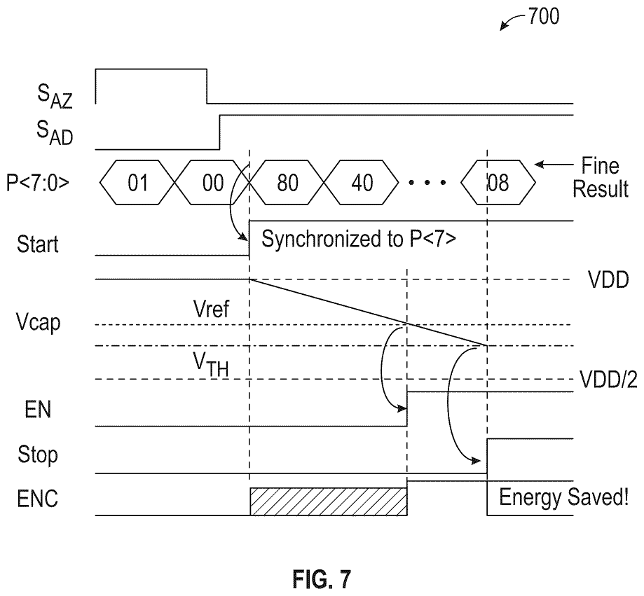

FIG. 6 shows a diagram of the ADC (116) in accordance with one or more embodiments. In some embodiments, the ADC (116) is an 8.5-bit dual-threshold time-domain (TD) ADC (116). The ADC (116) includes a voltage-to-time converter (VTC) (602), a Time-to-Digital Converter (TDC) (604), and a ring oscillator (RO) (606). In accordance with one or more embodiments, the RO (606) is a global 8-phase differential RO. The VTC (602) discharges the capacitors attached to the MAC Lines (112) until it reaches the threshold voltage of the zero detector (Cmp1), thus converting output voltage (Vcap) into a pulse. Due to the shift-and-add circuits (502), the integration capacitor of the VTC (602) is the combination of MOM capacitors from four slices (104). In one or more embodiments, the TDC (604) adapts a compact folding-flash TDC topology to avoid the exponentially increased area of conventional flash TDCs. The local registers sample the phases of the RO (606) to generate the 3-bit fine results, and the local counter triggered by one of the phases in the RO (606) generates the 6-bit coarse results. In some embodiments, the local registers that dominate the TDC (604) area utilize a custom true single-phase clocked (TSPC) structure. The RO (606) is free running to avoid a long settling time while synchronized to the ADC (116) start signal (S_{AD}) to prevent an uncertain initial state, as shown in the ADC operational waveforms (700) in FIG. 7. A safe-stop mechanism synchronizes the counter's Stop and Trigger signals, preventing possible MSB errors caused by a wrong count when the two signals collide. A second low-power comparator (Cmp2) is added to power gate Cmp1 and TSPCs. Cmp2 is auto-zeroed by S_{AZ} before conversion. Cmp2 has a slightly higher threshold (set by Vref) than Cmp1 to disable the main path of the ADC (116) most of the time to save its power consumption.

In FIG. 7, Cmp2 is started at the beginning of the conversion while the main path (Cmp1) is disabled. When the input voltage (Vcap) crosses Vref, Cmp1 and TDC are activated for high-accuracy VTC and TDC operations to obtain the overall ADC digital outputs (P<7:0> in FIG. 7).

Embodiments disclosed herein achieve a total capacitance almost doubling that of bit-serial (BS) counterparts, significantly reducing the thermal noise and the current source noise from the VTC (602). Further, embodiments disclosed herein achieve a superior voltage scalability (down to 0.65 V) and an ultra-compact area. In addition, with a shared RO (606), the ADC (116) occupies an area of 387.9 square micrometer (μm²) each, overall accounting for only 4.6% of the PIM macro (100) area. Further, sharing the RO (606) also benefits the phase noise and linearity since the stage delays can be up sized with few area and energy concerns. The local registers that dominate the TDC (604) area utilize a custom true single phase clocked (TSPC) structure which is 65% smaller than a standard-cell DFF, leading to further area reduction.

As previously noted, the key to the embedded capacitive computation is the recurrent usage over a single set of MOM capacitors for all analog tasks, including the C-DAC, analog MAC, analog shift-and-add and ADC, without extra peripheral circuitry. Throughout the entire analog processing chain, transistors only act as switches for fully charge-domain operations, eliminating PIM macro sensitivity to PVT variations of transistors. This approach is crucial for reducing area, mitigating computing nonlinearity, and eliminating buffering and sampling circuits. Meanwhile, despite various capacitor configurations for different tasks, the overhead of the computing circuitry in the array is reduced to minimal since it adopts a 6T-thin-cell-compatible layout.

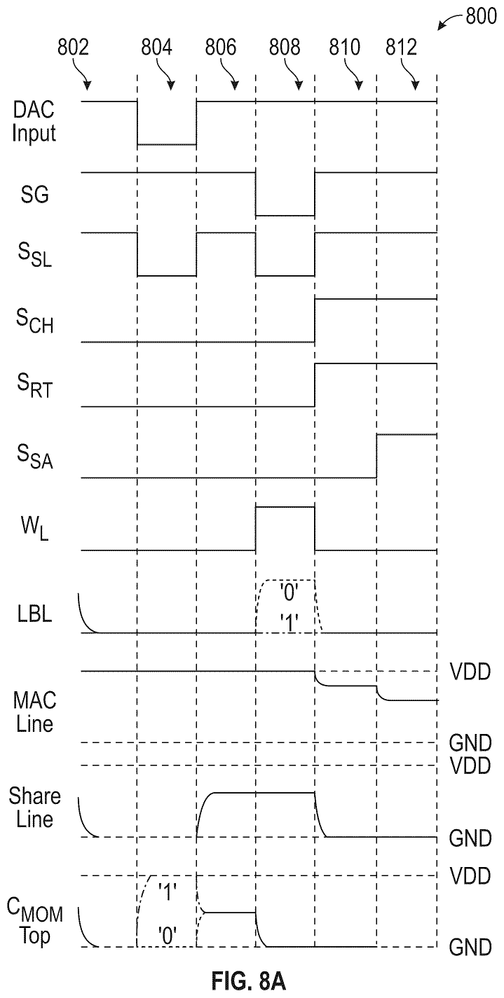

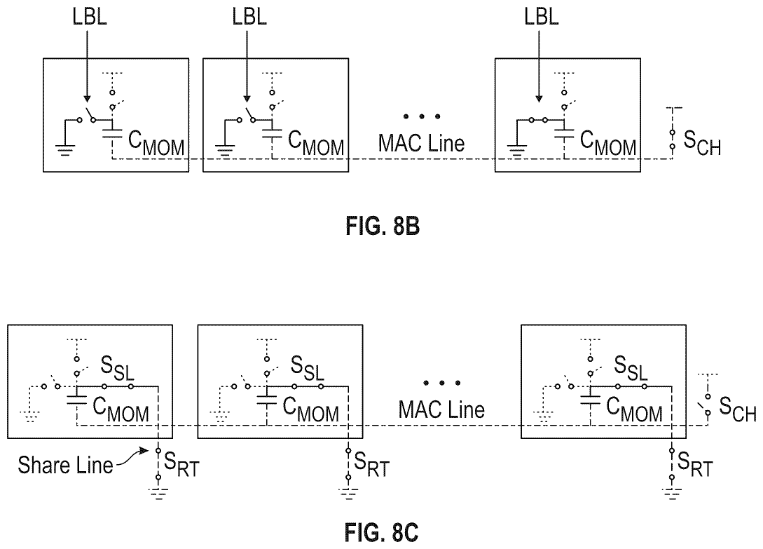

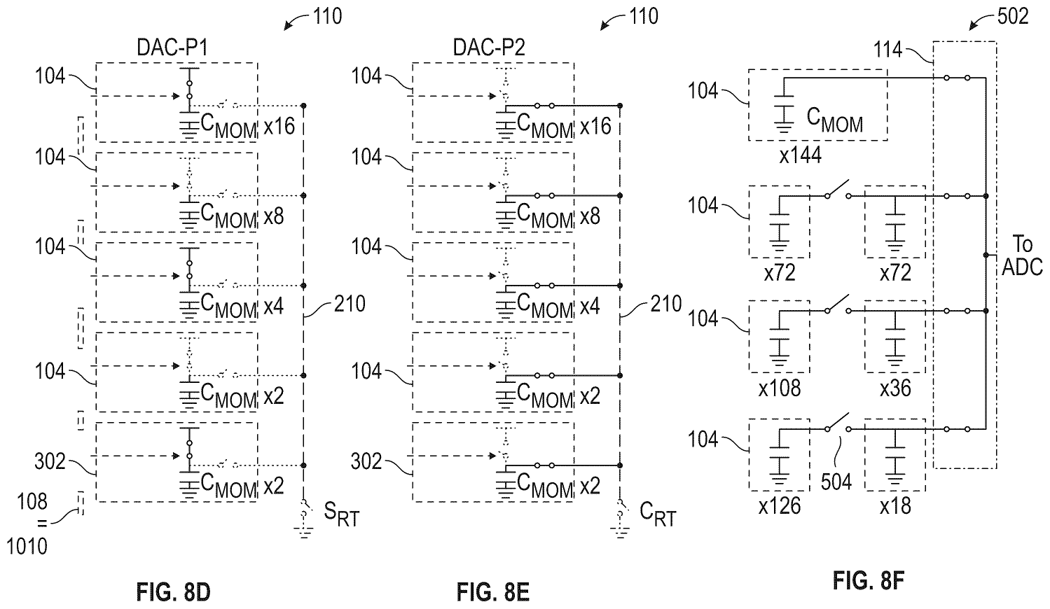

FIG. 8A shows operational waveforms (800) of the PIM macro (100) operation in accordance with one or more embodiments. The global bitline (GBL) is driven to ground throughout the PIM macro (100) operation. The PIM operation starts with a pre-charge (PCH) phase (802). During the PCH phase (802), the top plates of the MOM capacitors, MAC Lines (112), and Share Lines (210) are initialized to ground, VDD, and ground, respectively.

During the DAC phase 1 (DAC-P1) (804) and DAC phase 2 (DAC-P2) (806), the embedded C-DAC (110) takes advantage of all the MOM capacitors in a column, functioning as a reference generator, and samples the output voltage on the top plates of the MOM capacitors, while their bottom plates are grounded via MAC Lines (112). Specifically, during DAC-P1, S_{SL} and S_{RT} are set to a high (i.e., conducting) state to reset the MOM capacitors. Then, S_{SL} and S_{RT} are set to zero, and each bit of the 4-bit digital input (108) controls the switches K₁ in its corresponding slice. The top plates of the MOM capacitors are either set to V_{IN}, if the bit is ‘1’, or keep at the reset voltage V_{R}, if the bit is ‘0’. During DAC-P2, with S_{SL} set to a high (i.e., conducting) state, S_{RT} set to a low (i.e., non-conducting) state, and the switches K₁ turned off, the charge is shared through the Share Line (210) and the output voltage is sampled on the MOM capacitors.

As shown in FIG. 8B, during the multiplication (Mul.) operation (808), one of the WLs (206) is activated to engage M₁ and, depending on the data stored in the 6T SRAM cell (202), the MOM capacitors either discharge entirely or maintain their voltages. As a result, M₁ will either be turned on to reset the MOM capacitor, which is equivalent to multiplying the input by logic ‘0’, or remains off, which is equivalent to multiplying by logic ‘1’.

Keeping with FIG. 8A, during the accumulation (Acc.) operation (810), S_{SL} and S_{RT} are set to a high (i.e., conducting) state, grounding the top plates, and causing charge sharing across the MOM capacitors connected to the same MAC Line (112) in a given row. FIG. 8C shows the accumulation operation. During the charge-domain shift-and-add (S.A.) operation (812), enabled by S_{SA}, the shift-and-add circuit (502) reuses (i.e., reconfigures) the local MOM capacitors and conducts weighted charge-sharing across neighboring rows. After the analog PIM, the ADC (116) reuses (i.e., reconfigures) the MOM capacitors once more for voltage sampling and charge integration.

In accordance with one or more embodiments, FIG. 8D shows the configuration of the MOM capacitors during the first phase (P1) of the digital-to-analog (DAC-P1) operation (804) in an implementation where the MAC module (204) of FIG. 2B is used in each cluster (106). During DAC-P1 (804), the top plates of the MOM capacitors are either pulled up to VDD, if the bit is logic ‘1’ (0 V), or kept at zero if the bit is logic ‘0’ (VDD). For example, as shown in FIG. 8D, for a 4-bit digital input (108) equal to 1010, the top plates of the MOM capacitors in slides MSB (104), MSB-1 (104), MSB-2 (104), and LSB (104), are set to VDD, ground, VDD, and ground, respectively.

In accordance with one or more embodiments, FIG. 8E shows the configuration of the MOM capacitors during the second phase (P2) of the digital-to-analog (DAC-P2) operation (806) in an implementation where the MAC module (204) of FIG. 2B is used in each cluster (106). During DAC-P2 (806), the charge on the MOM capacitors is shared through the Share Line (210) vertically with S_{SL} set to a high (i.e., conducting) state and S_{RT} set to a low (i.e., non-conducting) state, as show in FIG. 8E. The output voltage is sampled on the MOM capacitors for future operations.

In accordance with one or more embodiments, FIG. 8F shows the configuration of the MOM capacitors during the shift-and-add (S.A.) operation (812) in an implementation where the MAC module (204) of FIG. 2B is used in each cluster (106). The MOM capacitors form an inter-slice weighted capacitive adder in this configuration. During the S.A. operation (812), after the charge-sharing-based accumulation is finished, the switches in the P-Sum Combiner (i.e., S_{SA}) are in a high state (i.e., conducting) to turn the separation switches (S̅_̅{̅S̅A̅}̅) off. Further, since the S_{SA} switches are turned on, the P-Sum Combiner (114) shift-and-adds the charge-sharing results of the four neighboring MAC Lines (112) in the charge-domain and thus completes a S.A. operation across four adjacent slices (104) in the charge-domain. S_{SL} and S_{RT} are high (i.e., conducting) during the S.A. operation to set the top plate of the MOM capacitors to ground. The P-Sum Combiner (114) transmits the final output voltage to the ADC (116) for digitalization.

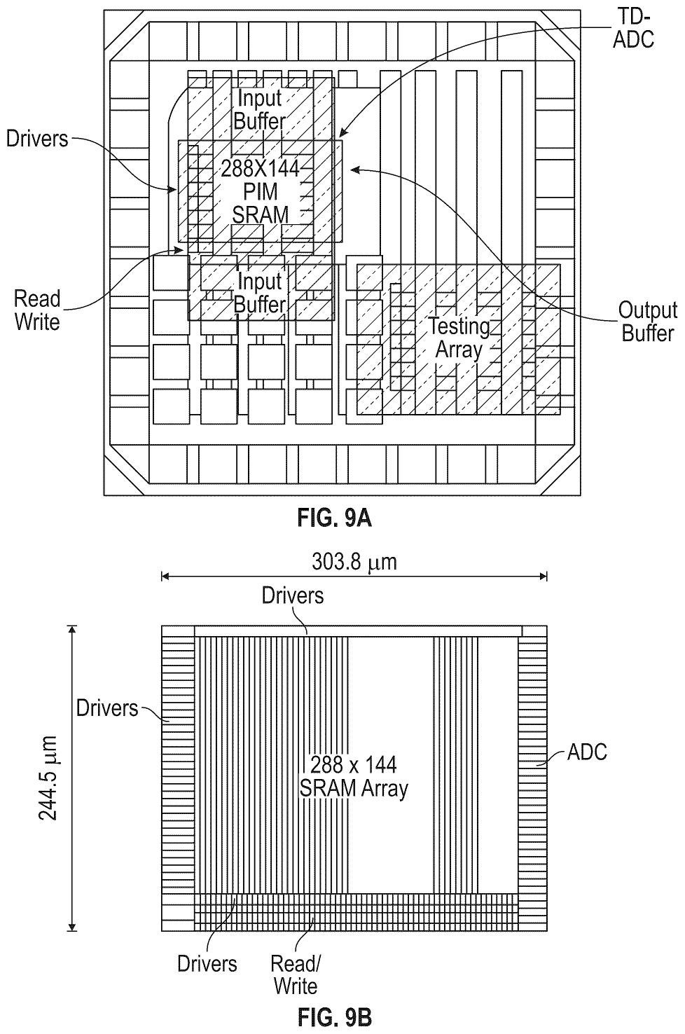

FIGS. 9A and 9B show a die micrograph and layout of a PIM macro (100) fabricated using 65 nanometer (nm) Low-Power (LP) CMOS technology, respectively. The PIM macro (100), with a memory capacity of 40.5 Kb, occupies an area of 0.074 square millimeter (mm²), where the memory array, vertical/horizontal drivers, and ADC (116) take 70.9%, 14.7%, and 4.6% of the total area, respectively. The area occupied by the C-DAC (110) is negligible since the C-DAC (110) is embedded into the array. The PIM macro (100) is interfaced for testing with a host computer through a field-programmable gate array (FPGA).

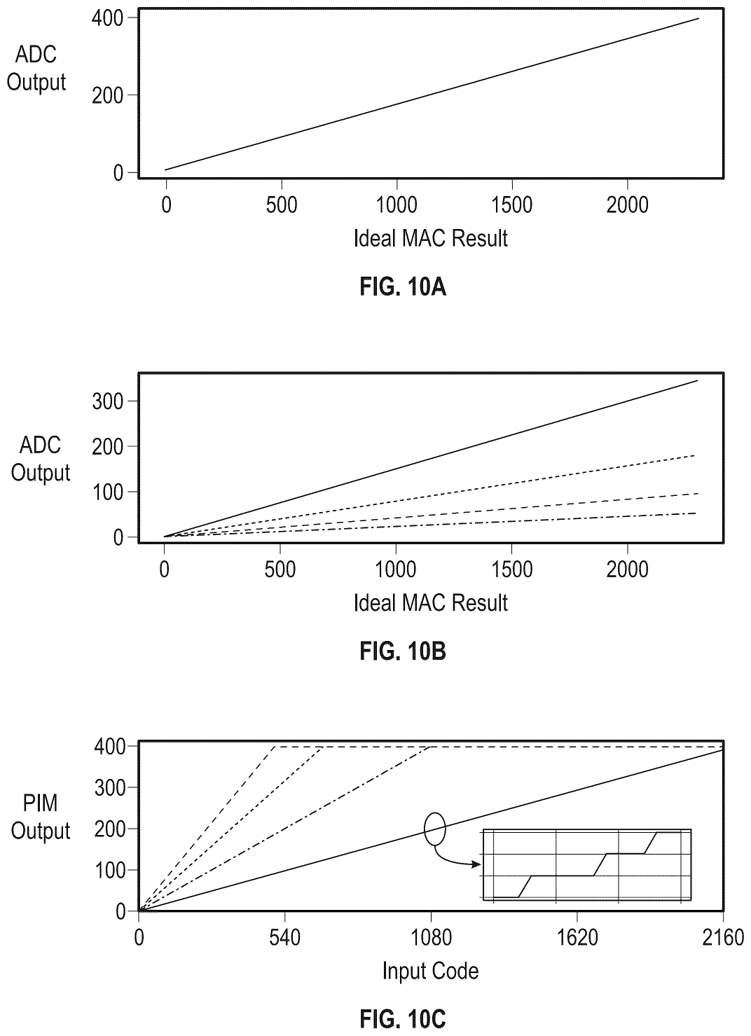

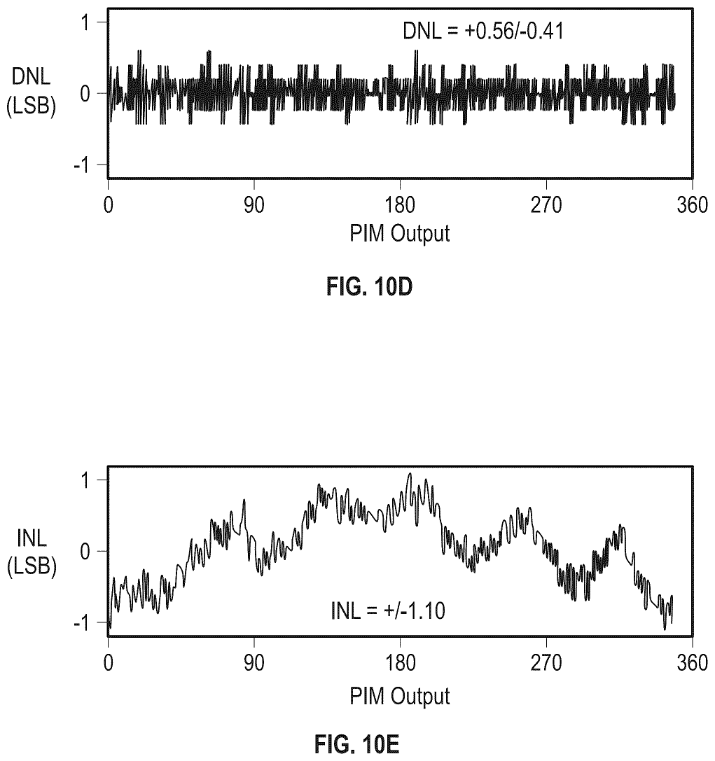

All analog components in the computing path, including the C-DAC (110), MAC units (102), shift-and-add circuits (502), and ADC (116), contribute to the nonidealities of the PIM macro (100). FIGS. 10A-10C show linearity measurements of the MAC units (102) in accordance with one or more embodiments. Specifically, FIGS. 10A and 10B show the measured linearity of the eight MAC units (102) when the weights stored in the 6T SRAM cells (202) are ‘1111’ and ‘1000’, ‘0100’, ‘0010 and ‘0001’, respectively. FIG. 10C shows linearity measurements where all ‘1’s are stored in the 6T SRAM cells (202). Thus, nonlinearities from the C-DAC (110), MAC units (102), and ADC (116) are included in these measurements. The input code is sweep from 0 to a maximum of 2160. FIGS. 10D and 10E shows Differential Non-Linearity (DNL) and Integral Non-Linearity (INL) performance with a gain of 1 in accordance with one or more embodiments. As shown in FIGS. 10D and 10E, for a typical 8.5-bit MAC unit without any calibration, DNL and INL are bounded between +0.56/−0.41 and +/−1.10 LSB, respectively. The major error comes from the ADC (116) due to the restricted area for layout matching. By tuning the reference current in the VTC (602), the analog computing voltage can be amplified with a gain of up to 4 while maintaining satisfactory linearity. Thus, providing this gain effectively reduces the quantization error.

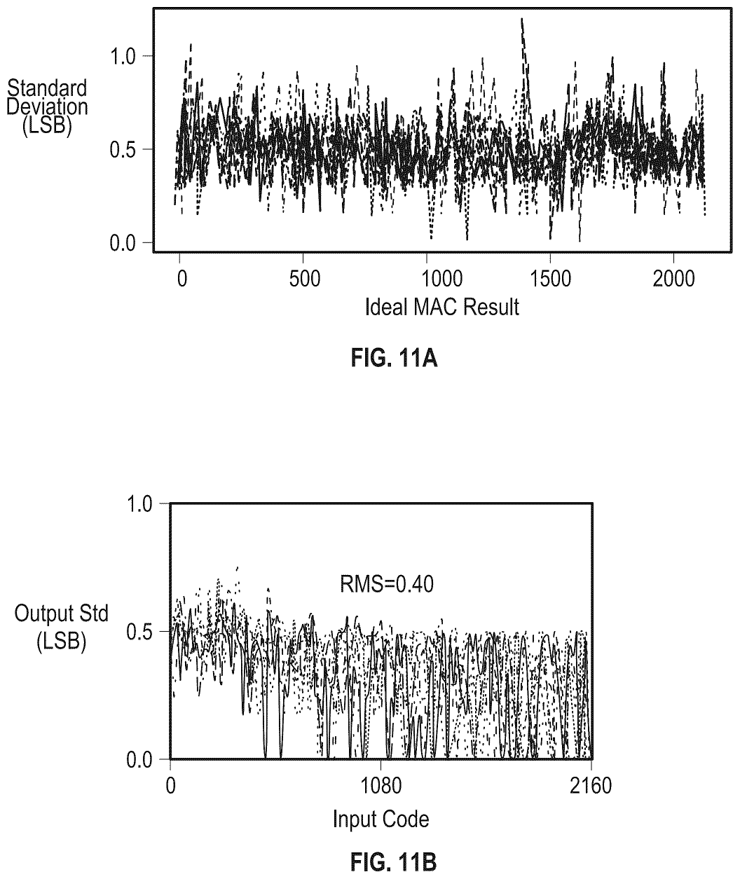

FIGS. 11A and 11B characterize the influence of thermal noise on the PIM macro (100). Specifically, FIGS. 11A and 11B show the measured root-mean-square (RMS) standard deviation (Std.) of PIM outputs across all input codes for eight MAC units (102). The RMS standard deviation is measured by input sweeping and with each code repeating 50 times. FIGS. 11A and 11B show that the measured RMS standard deviation across eight MAC units (102) is 0.4 LSB. This noise level is sufficient for systems targeting low power and small areas yet can be further improved with a larger capacitor value, a less noisy RO, and a lower-noise zero detector. Considering both random errors and nonlinearity, a computation error distribution shows a standard deviation of 0.59 LSB.

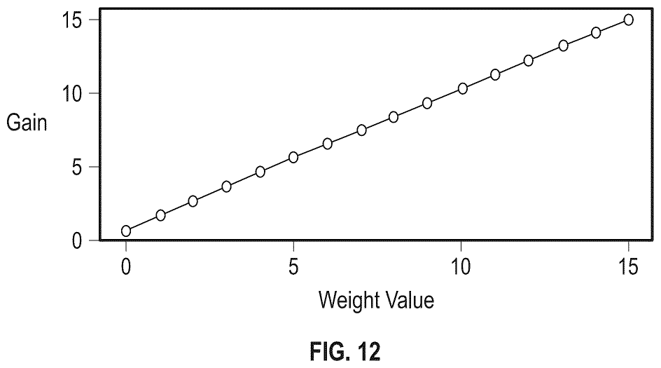

FIG. 12 characterizes the linearity of the shift-and-add circuits (502). All 4-bit weights in the 6T SRAM cells (202) are programmed to the same value. For each possible weight value, the input is swept to obtain a transfer curve and calculate its slope. Ideally, the slope of the curve increases linearly with the weight value. FIG. 12 plots the measured slopes (i.e., gain) of all 16 transfer curves with different weight configurations, showing consistent steps between neighboring codes. The superior linearity proves the high accuracy of the charge-domain shift-and-add circuits (502). The largest error happens at code ‘1000’, where three bits are flipped from the last code ‘0111’. Despite the capacitor matching, this error still exists because of the parasitic capacitors from the additional separation switches (504), pre-chargers (S_{CH} and S_{RT}), and P-Sum Combiners (114) connected to the MAC Line (112).

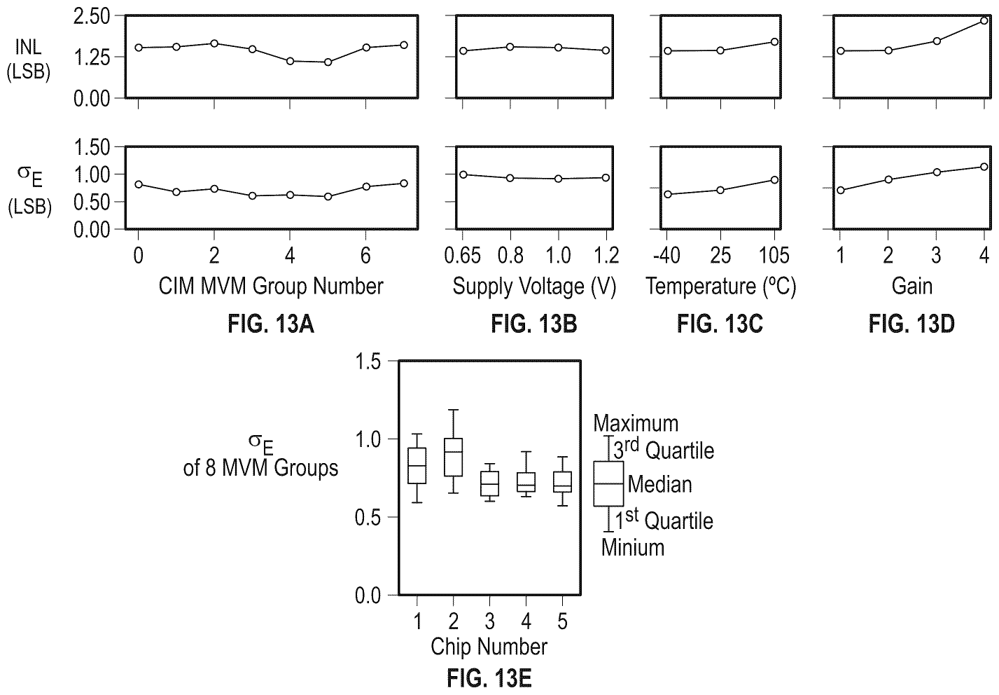

As previously stated, based solely on passive components, the PIM macro (100) disclosed herein achieves superior tolerance of PVT variations. The ADC (116) also has great scalability to voltage. FIG. 13A examines PVT and different gain variations by measuring the standard deviation (σ_{E}) and INL of eight MAC units (102) in a single macro, where the difference between the best and worse ones is only 0.24 and 0.58 LSB, respectively. In addition, FIGS. 13B and 13C evaluates σ_{E} and INL across 0.65 to 1.2 V and −40 to 105° C., proving the robustness over voltage and temperature variations. In addition to PVT variations, the computing accuracy under different gains when tuning the reference current is also examined in FIG. 13D. Theoretically, a smaller reference current results in a greater gain and a smaller quantization error, but also incurs more noise in the current source. As shown in FIGS. 13A-13D, σ_{E} and INL scale much slower than the gain, which proves that the benefits of reduction in quantization errors outweigh the incurred nonidealities. FIG. 13E evaluates σ_{E} across 5 chips, showing the similar distribution of σ_{E} across eight MAC units (102) in each chip.

Embodiments disclosed herein achieve a weight storage density of 559 Kb/mm² and exceptional robustness to temperature and voltage variations (−40 to 105° C. and 0.65 to 1.2 V) among SRAM-based analog PIM designs. Further, including all the extra area for PIM, the memory density of the PIM macro (100) disclosed herein is only 31% lower than a logic-rule 6T SRAM cell (202), similar to that of an 8T SRAM. In addition, the PIM macro (100) achieves 3.6× memory density. In practice, embodiments disclosed herein are especially beneficial to PIM systems targeting fully on-chip weight storage for medium-sized models in ultra-low-power edge devices.

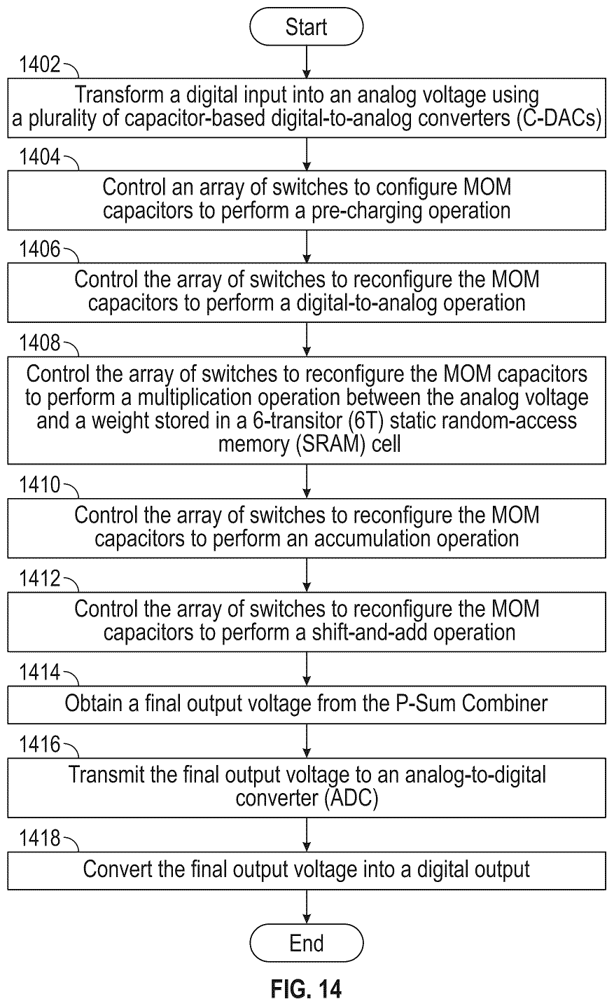

FIG. 14 depicts a method for operating a PIM macro device (100) in accordance with one or more embodiments. It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In Block 1402, the 4-bit digital input (108) is transformed into an analog voltage using a plurality of C-DACs (110). The C-DAC (110) achieves a smaller area overhead by reusing MOM capacitors in the memory array as a capacitive voltage divider. The MOM capacitors are shared between the C-DACs (110) and the MAC units (102) and include a top plate and a bottom plate. Further, the MOM capacitors also sample the output voltage of the C-DAC (110) so that no extra analog output buffers are required. Inside the C-DAC (110), 32 clusters (106) combine into a column with a Share Line (210) connected together. To realize the embedded C-DAC (110), one memory column is divided into 4 slices (104). The switches K₁ in each slice (104) are controlled by a different bit from the 4-bit digital input (108). The number of clusters in a slice (104) (i.e., 16, 8, 4, and 2) represents the weight of the corresponding digital input (108) bit.

In Block 1404, the array of switches configure the MOM capacitors to perform a pre-charging operation (PCH). During PCH (802), the top plates of the MOM capacitors, MAC Lines (112), and Share Lines (210) are initialized to ground, VDD, and ground, respectively.

In Block 1406, the array of switches reconfigure the MOM capacitors to perform a digital-to-analog operation (DAC-P1 and DAC-P2). During DAC-P1 (804) and DAC-P2 (806), the embedded C-DAC (110) takes advantage of all the MOM capacitors in a column, functioning as a reference generator, and samples the output voltage on the top plates of the MOM capacitors, while their bottom plates are grounded via MAC Lines (112). Specifically, during DAC-P1, S_{SL} and S_{RT} are set to a high (i.e., conducting) state to reset the MOM capacitors. Then, S_{SL} and S_{RT} are set to zero, and each bit of the 4-bit digital input (108) controls the switches K₁ in its corresponding slice. The top plates of the MOM capacitors are either set to V_{IN}, if the bit is ‘1’, or keep at the reset voltage V_{R}, if the bit is ‘0’. During DAC-P2, with S_{SL} set to a high (i.e., conducting) state, S_{RT} set to a low (i.e., non-conducting) state, and the switches K₁ turned off, the charge is shared through the Share Line (210) and the output voltage is sampled on the MOM capacitors.

In Block 1408, the array of switches reconfigure the MOM capacitors to perform a multiplication operation between the analog voltage and a weight stored in a 6-transitor (6T) static random-access memory (SRAM) cell. During the multiplication (Mul.) operation (808), one of the WLs (206) is activated to engage M₁ and, depending on the data stored in the 6T SRAM cell (202), the MOM capacitors either discharge entirely or maintain their voltages. As a result, M₁ will either be turned on to reset the MOM capacitor, which is equivalent to multiplying the input by logic ‘0’, or remains off, which is equivalent to multiplying by logic ‘1’.

In Block 1410, the array of switches reconfigure the MOM capacitors to perform an accumulation operation. During the accumulation (Acc.) operation (810), S_{SL} and S_{RT} are set to a high (i.e., conducting) state, grounding the top plates, and causing charge sharing across the MOM capacitors connected to the same MAC Line (112) in a given row.

In Block 1412, the array of switches reconfigure the MOM capacitors to perform a shift-and-add operation. During the charge-domain shift-and-add (S.A.) operation (812), enabled by S_{SA}, the shift-and-add circuit (502) reuses (i.e., reconfigures) the local MOM capacitors and conducts weighted charge-sharing across neighboring rows. In addition, during the S.A. operation (812), and after the charge-sharing-based accumulation is finished, the switches in the P-Sum Combiner (i.e., S_{SA}) are in a high state (i.e., conducting) to turn the separation switches (S̅_̅{̅S̅A̅}̅) off. Further, since the S_{SA} switches are turned on, the P-Sum Combiner (114) shift-and-adds the charge-sharing results of the four neighboring MAC Lines (112) in the charge-domain and thus completes a S.A. operation across four adjacent slices (104) in the charge-domain. S_{SL} and S_{RT} are high (i.e., conducting) during the S.A. operation to set the top plate of the MOM capacitors to ground.

In Block 1414, a final output voltage is obtained from the P-Sum Combiner (114). In Block 1416, the P-Sum Combiner (114) transmits the final output voltage to the analog-to-digital converter (ADC) (116) for digitalization.

In Block 1418, the ADC (116) converts the final output voltage into a digital output. In some embodiments, the ADC (116) is an 8.5-bit dual-threshold time-domain (TD) ADC (116). The ADC (116) includes a voltage-to-time converter (VTC) (602), a Time-to-Digital Converter (TDC) (604), and a ring oscillator (RO) (606). In accordance with one or more embodiments, the RO (606) is a global 8-phase differential RO. The VTC (602) discharges the capacitors attached to the MAC Lines (112) until it reaches the threshold voltage of the zero detector (Cmp1), thus converting output voltage (Vcap) into a pulse. Due to the shift-and-add circuits (502), the integration capacitor of the VTC (602) is the combination of MOM capacitors from four slices (104). In one or more embodiments, the TDC (604) adapts a compact folding-flash TDC topology to avoid the exponentially increased area of conventional flash TDCs. The local registers sample the phases of the RO (606) to generate the 3-bit fine results, and the local counter triggered by one of the phases in the RO (606) generates the 6-bit coarse results. In some embodiments, the local registers that dominate the TDC (604) area utilize a custom true single-phase clocked (TSPC) structure. The RO (606) is free running to avoid a long settling time while synchronized to the ADC (116) start signal (S_{AD}) to prevent an uncertain initial state. A safe-stop mechanism synchronizes the counter's Stop and Trigger signals, preventing possible MSB errors caused by a wrong count when the two signals collide. A second low-power comparator (Cmp2) is added to power gate Cmp1 and TSPCs. Cmp2 is auto-zeroed by S_{AZ} before conversion. Cmp2 has a slightly higher threshold (set by Vref) than Cmp1 to disable the main path of the ADC (116) most of the time to save its power consumption.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A processing-in-memory (PIM) macro device comprising:
a plurality of capacitor-based digital-to-analog converters (C-DACs), wherein the C-DACs transform a digital input into an analog voltage;
a plurality of multiply-and-add (MAC) units, each MAC unit comprising:
a plurality of slices, wherein each slice comprises a plurality of clusters,
wherein each cluster in the plurality of clusters comprises a 6-transitor (6T) static random-access memory (SRAM) cell and a MAC module;
a partial-sum combiner (P-Sum Combiner) that performs a shift-and-add operation across multiple slices within the MAC unit;
an analog-to-digital converter (ADC) configured to convert a final output voltage from the P-Sum Combiner into a digital output; and
a Share Line, a MAC Line, a plurality of wordlines (WLs), and a local bitline (LBL);
an array of metal-oxide-metal (MOM) capacitors configured to store a charge, each capacitor comprising a top plate and a bottom plate, wherein the MOM capacitors are shared between the C-DACs and the MAC units; and
an array of switches configured to be controlled to configure the MOM capacitors to perform a first operation and to reconfigure the MOM capacitors to perform a second operation.

2. The PIM macro device of claim 1,
wherein the plurality of C-DACs are integrated in-situ with the plurality of MAC units,
wherein the ADC comprises a time-domain ADC.

3. The PIM macro device of claim 1, wherein the array of switches reconfigure the MOM capacitors to perform a pre-charging operation comprising:
setting the top plate of the MOM capacitors to a ground voltage;
setting the MAC Line to a VDD voltage; and
setting the Share Line to a ground voltage.

4. The PIM macro device of claim 1, wherein the array of switches reconfigure the MOM capacitors to perform a digital-to-analog operation comprising:
if a bit value of the digital input is equal to 1:
setting the top plate of the MOM capacitors to a VDD voltage;
if a bit value of the digital input is equal to 0:
setting the top plate of the MOM capacitors to a ground voltage;
sharing a charge stored in the top plate of the MOM capacitors between one or more MAC modules using the Share Line; and
setting the bottom plate of the MOM capacitors to a ground voltage using the MAC Line.

5. The PIM macro device of claim 1, wherein the array of switches reconfigure the MOM capacitors to perform a multiplication operation comprising:
activating one of the plurality of WLs; and
setting a voltage of the MOM capacitors based on a value of a weight stored in the 6T SRAM cell.

6. The PIM macro device of claim 1, wherein the array of switches reconfigure the MOM capacitors to perform an accumulation operation comprising:
setting the top plate of the MOM capacitors to a ground voltage; and
sharing a charge stored in the MOM capacitors between one or more MAC modules using the MAC Line.

7. The PIM macro device of claim 1, wherein the array of switches reconfigure the MOM capacitors to perform a shift-and-add operation comprising:
disconnecting one or more MAC Lines;
connecting one or more MAC modules using the P-Sum Combiner; and
transmitting the final output voltage to the ADC.

8. The PIM macro device of claim 1, wherein the ADC comprises a voltage-to-time converter (VTC), a Time-to-Digital Converter (TDC), and a ring oscillator (RO).

9. The PIM macro device of claim 1, wherein the array of switches comprises:
a first switch (S_{CH}) shared across one or more MAC modules using the MAC Line;
a second switch (S_{RT}) shared across the one or more MAC modules using the Share Line;
a third switch (S_{SL}) disposed within the MAC module;
a fourth switch (S_{SA}) configured to disconnect the MAC line;
a fifth switch (K₁) switch disposed within the MAC module and controlled by a bit value of the digital input;
a sixth switch (M₁) disposed within the MAC module and controlled by the LBL; and
a seventh switch (S_{G}) connected to the LBL and a global bitline (GBL).

10. The PIM macro device of claim 1, wherein the array of switches comprises an N-channel metal-oxide semiconductor (NMOS), a p-channel metal-oxide semiconductor (PMOS), or a transmission gate.

11. The PIM macro device of claim 1, wherein each MAC unit comprises a shift-and-add circuit.

12. The PIM macro device of claim 1,
wherein each of the plurality of MAC units performs vector-vector multiplication,
wherein the PIM macro device performs matrix-vector multiplication.

13. The PIM macro device of claim 1, wherein the PIM macro device comprises a global bit line (GBL), control line drivers, and SRAM read and write periphery circuits.

14. The PIM macro device of claim 1, wherein each cluster stores a weight in the 6T SRAM cell and activates one of the plurality of WLs during one or more operations.

15. The PIM macro device of claim 1,
wherein each MAC unit comprises a dummy p-channel metal-oxide semiconductor (PMOS) with a drain and a source,
wherein each MAC unit comprises a thin-cell layout,
wherein the PIM macro device is fabricated using complementary metal-oxide semiconductor (CMOS) technology.

16. A method for operating a processing-in-memory (PIM) macro device, comprising:
transforming a digital input into an analog voltage using a plurality of capacitor-based digital-to-analog converters (C-DACs),
wherein the C-DACs comprise an array of metal-oxide-metal (MOM) capacitors configured to store a charge, each capacitor comprising a top plate and a bottom plate,
wherein the MOM capacitors and are shared between the C-DACs and a plurality of PIM multiply-and-add (MAC) units;
controlling an array of switches to configure the MOM capacitors to perform a pre-charging operation comprising:
setting the top plate of the MOM capacitors to a ground voltage;
setting a MAC Line to a VDD voltage; and
setting a Share Line to a ground voltage; and
controlling the array of switches to reconfigure the MOM capacitors to perform a digital-to-analog operation comprising:
setting the top plate of the MOM capacitors to a voltage determined based on a bit value of the digital input;
sharing a charge stored in the top plate of the MOM capacitors between one or more MAC modules using the Share Line; and
setting the bottom plate of the MOM capacitors to a ground voltage using the MAC Line.

17. The method of claim 16, further comprising:
controlling the array of switches to reconfigure the MOM capacitors to perform a multiplication operation between the analog voltage and a weight stored in a 6-transitor (6T) static random-access memory (SRAM) cell, the multiplication operation comprising:
activating one of a plurality of wordlines (WLs) in the 6T SRAM cell; and
setting a voltage of the MOM capacitors based on a value of a weight stored in the 6T SRAM cell.

18. The method of claim 16, further comprising:
controlling the array of switches to reconfigure the MOM capacitors to perform an accumulation operation comprising:
setting the top plate of the MOM capacitors to a ground voltage; and
sharing the charge stored in the MOM capacitors between one or more MAC modules using the MAC Line.

19. The method of claim 16, further comprising:
controlling the array of switches to reconfigure the MOM capacitors to perform a shift-and-add operation comprising:
disconnecting one or more MAC Lines; and
connecting one or more MAC modules using a P-Sum Combiner.

20. The method of claim 19, further comprising:
obtaining a final output voltage from the P-Sum Combiner;
transmitting the final output voltage to an analog-to-digital converter (ADC); and
converting the final output voltage into a digital output.
